(19) United States
(12) Patent Application Publication
(10) Pub. No.: US 2014/0180701 A1
(43) Pub. Date: Jun. 26, 2014

(54) SYSTEMS AND METHODS FOR SECURE HEALTHCARE MESSAGING

(71) Applicant: GS Healthcare Innovations LLC, Potomac, MD (US)

(72) Inventors: Alex GRILLI, Westwood, MA (US); Rahul K. SHAH, Potomac, MD (US)

(73) Assignee: GS Healthcare Innovations LLC, Potomac, MD (US)

(21) Appl. No.: 14/075,030

(22) Filed: Nov. 8, 2013

Related U.S. Application Data
(60) Provisional application No. 61/745,169, filed on Dec. 21, 2012.

(51) Int. Cl. G06F 19/00; H04L 12/58

(52) U.S. Cl. CPC G06F 19/322; H04L 51/24
USPC 705/2

(57) ABSTRACT

Various implementations of a message system may provide secure means of messaging between healthcare professionals in accordance with the Health Insurance Portability and Accountability Act (HIPAA).

### CROSS-REFERENCE TO RELATED APPLICATIONS

This application claims the benefit of priority to U.S. Prov. App. 61/745,169 filed Dec. 21, 2012, which is incorporated herein by reference in its entirety.

### TECHNICAL FIELD OF THE INVENTION

Various aspects of the disclosed technology relate to electronic communications, messaging, and, more particularly, to secure messaging that may comply with the Health Insurance Portability and Accountability Act (HIPAA).

### BACKGROUND OF THE INVENTION

The Privacy and Security provisions of HIPAA, and its implementing regulations, create a framework of federal law to protect individually identifiable health information (IIHI). HIPAA requires that IIHI only be used and disclosed in a manner that protects the privacy and security of such information. Under the HIPAA Security Regulations, Covered Entities, which includes most healthcare providers, and their Business Associates are required to implement administrative, physical, and technical safeguards that ensure the confidentiality, integrity, and availability of electronic IIHI. These safeguards are designed to:

1. Ensure the confidentiality, integrity, and availability of all electronic IIHI that the Covered Entity or Business Associate creates, receives, maintains, or transmits;

2. Protect against any reasonably anticipated threats or hazards to the security or integrity of such information;

3. Protect against any reasonably anticipated uses or disclosures of such information that are not permitted by the HIPAA Privacy Regulations; and,

4. Ensure compliance with the HIPAA Security Regulations by the Covered Entity or Business Associate's workforce.

The proliferation and convenience of mobile applications, including, but not limited to texting and email and other means of electronic communication have resulted in electronic IIHI being exchanged among healthcare providers via non-secure means that do not comply with the HIPAA Security Rule requirements.

### SUMMARY OF THE INVENTION

There is a need for systems and methods to facilitate messaging related to healthcare in a secure manner that complies with HIPAA. It is to such systems and methods that various implementations of the disclosed technology are directed.

The message system may be available only to healthcare professionals or other persons who are involved in the healthcare field and who require access to IIHI (Authorized Persons). In some embodiments, the message system may be available to patients as well on a limited basis (for example, to communicate with an established provider known to the patient and the provider knows the patient). To access the system, an Authorized Person may first be required to register. To this end, the Authorized Person may enter information about himself to authenticate his identity, including any asserted medical licenses. Before the registration is approved, an administrator of the message system may confirm the Authorized Person's identity. Once the Authorized Person's identity is confirmed and the Authorized Person is permitted to use the message system, such Authorized Person becomes a “user.” For continued access to the message system, the user's identity and asserted licenses may be confirmed periodically, such as every six months.

After registration, including administrator approval, the user may access the functions of the message system, which may include an inbox, a search feature, and a message-sending function. Through the inbox, the user may retrieve messages sent to him through the message system. In some implementations, these messages may be stored on a remote server of the message system and not retained locally except as needed to display the messages.

Each user may be assigned a script for unique identification. The script may be a computer-generated sequence of characters, which may encode various information about the associated user, including, for example: state in which the user is licensed, specialty Board certification, location, and health plan participation or affiliation. If a user performs a search within the message system, or otherwise chooses to view a list of other users registered to the system, the message system may display the scripts of the various other users. The scripts may provide a convenient means for the message system to filter users during a search, and may also provide a convenient means for a user familiar with the system to quickly identify other users with whom the user may want to communicate.

Additionally, the script provides a convenient and efficient means to facilitate targeted advertisements to users within a specific specialty (e.g., orthopedics) and geographical location (e.g., New York) such that products and services of particular interest (e.g., replacement knee manufacturer representatives for greater New York area) are selected for viewing based upon the unique identification provided in the script.

Furthermore, the script may also be optionally encoded to facilitate various levels of profiling of the user. For example, “premium” profiling may allow for a user to pay a fee to the service provider to provide customized (or personalized) wording adjacent to the script so that this user can better define themselves to the professional network or other users of the application.

After using the search feature or other means of selecting a recipient, the user may draft a message to his intended recipient. The message may be securely transmitted to the server for temporary storage. Upon receipt, the server may transmit notification of the new message to the recipient. In an example implementation, the notification may be delivered to the user via email, SMS text, or notification bar on a mobile device. Display of the content of the message itself may be withheld until the recipient is logged into the message system and requests to read the message.

To reduce the number of messages that could potentially be accessed without permission, for example, if the server is hacked, the message system may employ one or more security measures. These may include standard measures, such as firewalls and data encryption. Additionally, the message system 100 may automatically delete messages from the server when predetermined conditions are met. For example, and not limitation, the message system may purge read messages 72 hours after they are read, and may purge unread messages two weeks after they are sent.

These and other objects, features, and advantages of the disclosed technology will become more apparent upon reading the following specification in conjunction with the accompanying drawing figures and appendices.

### BRIEF DESCRIPTION OF THE FIGURES AND APPENDICES

FIG. 1 illustrates a diagram of the message system, according to an example implementation of the disclosed technology.

FIG. 2 illustrates an architecture of a computing device for providing some aspects of the disclosed technology, according to an example implementation.

Appendices are enclosed describing particular implementations of the disclosed technology and are incorporated herein by reference. It will be understood that these implementation descriptions are provided for illustration only and do not limit the various potential implementations of the disclosed technology.

Appendix A provides a list of abbreviations used in identifiers representing users of a message system according to an example implementation of the disclosed technology.

Appendix B provides various details related to an example implementation of the disclosed technology.

### DETAILED DESCRIPTION OF THE INVENTION

To facilitate an understanding of the principles and features of the disclosed technology, illustrative implementations are explained below. Various implementations of the disclosed technology are message systems and methods for delivering messages in compliance with HIPAA. Implementations of the disclosed technology, however, are not limited to this context. Rather, implementations may facilitate secure messaging for a variety purposes, inside or outside a healthcare context. For example, and not limitation, an implementation of the message system may be used to exchange secure messages between business associates regarding strictly confidential, non-healthcare-related matters.

The components described hereinafter as making up various elements of the disclosed technology are intended to be illustrative and not restrictive. Many suitable components that would perform the same or similar functions as components described herein are intended to be embraced within the scope of the message systems and methods. Such other components not described herein may include, but are not limited to, components developed after the disclosed technology.

Referring now to the figures, in which like reference numerals represent like parts throughout the views, various implementations of the message systems and methods will be described in detail.

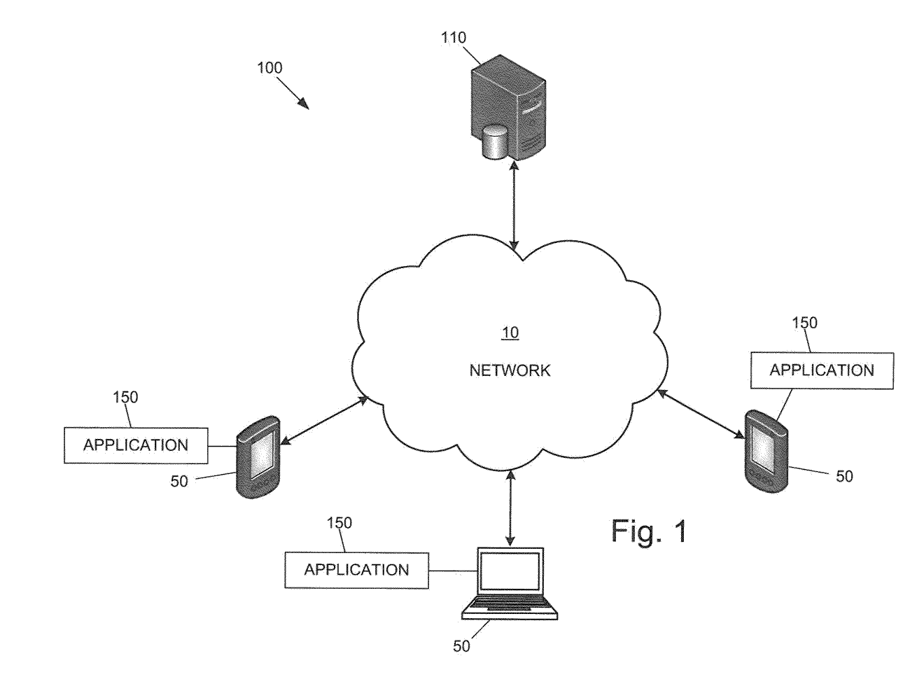

FIG. 1 illustrates a diagram of the message system 100, according to an example implementation of the disclosed technology. As shown, the message system 100 may be contained, in whole or in part, in a server assembly 110 in communication with a plurality of remote computing devices 50 over a network 10. The computing devices 50 may be various types of devices capable of accessing the server assembly 110, including, for example, mobile phones, tablets, desktop computers, and notebook computers.

In an example implementation, the server assembly 110 may be distributed across multiple server devices, which may be positioned in geographically different locations. The various servers may store redundant data to reduce the possibility that messages on the server assembly 110 are lost or corrupted. Alternatively, the servers may each contain different data, thus ensuring that all servers must be hacked in order for the message system's complete data to be maliciously retrieved.

Various security measures may be employed to protect data on the server assembly 110. Multiple layers of hacker protection may be used, including, for example, web application firewalls, intrusion detection systems, log management, hardened server configurations, and a robust patch-management regimen. Maintenance to the message system 100 may be performed via virtual private network (VPN), for example, using two-factor authentication. Regular vulnerability scans, penetration testing, and other security assessments may be performed. A rigorous backup regimen may include multiple generations of backup using multiple technologies. Additionally, for providing functionality of the message system 100, the server assembly 110 may include a web application and one or more databases, which may be stored on separate servers for security purposes. It will be understood that the term “database,” as used herein, is not limited to a relational database, but may include various mechanisms for storing or organizing data.

The message system 100 may include an installable application 150 that may be used on each computing device 50, independently of its use on other computing devices 50. Some implementations of the message system 100 may alternatively be web-based, thus enabling users to access and send secure messages without having performed an installation (for instance, utilizing the concept of “cloud” computing for secure messaging rather than device based). Even when installed, in some implementations, the application 150 may be configured to use an internal web browser to access the message system 100 as a web application. In some implementations, the internal web browser does not cache any pages, so when it closes, no data from the application 150 remains on the computing device 50.

In an example implementation, a user at a computing device 50 may be required to authenticate himself to the message system 100, such as through the application 150, before beginning a session of transmitting or receiving messages. To enable authentication, the user may first be required to register with the message system 100 to initiate his account. During registration, the message system 100 may prompt the user to enter his name and, if applicable, license information, as well as various other information applicable to verifying the user's identity and eligibility.

An administrator of the message system 100 may receive notification of new registrations. Before granting access to a user, the administrator may verify the user's identity, such as by placing one or more telephone calls, sending one or more emails, or checking one or more databases for verification. For security reasons, in some implementations, full functionality of the message system 100 may be limited to Authorized Persons.

Patients may have limited access to the message system 100, for retrieving and sending messages related to their own care. Patients may be charged a fee for this service, and part of that fee may be delivered to the healthcare professionals interacting with the patients, in return for their time. As will be described later in this disclosure, messages may be removed from the message system 100 after predetermined periods of time, so as to reduce the amount of potentially confidential data stored by the message system 100 at any one time. Thus, to keep accurate records for charging patients, the message system 100 may retain information about when and between whom messages are sent, even after discarding the content of the messages.

If a registering individual claiming to be an Authorized Person cannot be verified as such, the message system 100 may transmit an email or other message to the individual informing the individual that access to the message system 100 is not permitted. Alternatively, if the individual is verified, the administrator may confirm the registration and transmit initial login instructions, e.g., an initial password, to the individual, who then becomes a new user. After the user is logged in for the first time, the application 150 may require or ask the user to accept an End User License Agreement and to provide new data for authentication in future sessions. This new data may be, for example, a password or a pattern behaving as a password to identify the user.

For pattern entry with a touch-sensitive device, the application 150 may provide a predetermined layout of symbols, such as circles arranged in a three-by-three grid. In some implementations, an image may be overlaid on each circle, or other symbol. For example, a caduceus may be displayed inside each symbol. Through a touch-sensitive surface, the user may trace a pattern connecting two or more of the symbols. Such a pattern may be used in place of, or in addition to, a password for authentication purposes. While the use of a touch-sensitive surface on a portable device may be used, other devices such as personal computers which are typically not readily portable may also be used. In such cases, patterns may be traced on the screen of the device (e.g., via an input device like a computer mouse) or through a separate peripheral device which may optionally incorporate a touch-sensitive surface.

The message system 100 may have predetermined requirements for the password or pattern, to ensure that the password or pattern is sufficiently strong to reduce the chance of malicious access. Built-in password complexity rules may ensure strong passwords, which reduces the viability of brute force attacks. Furthermore, the message system 100 may require that a password be changed periodically, such as every six months. Password history may be maintained to ensure that passwords are not recycled.

After the user sets his authentication data for future logins, the application 150 may transmit this data to the server assembly 110, where it may be stored securely. For example, the application 150 may encrypt the authentication data before transmission, and the server assembly 110 may store the encrypted version. In the future, the user may use the authentication data to begin each session with the message system 100.

To facilitate authentication in the future, the application 150 may present one or more fields for the user to fill out, such as a user name field and a password field or, alternatively, a pattern entry field. When the user completes the required fields and submits the associated data, the application 150 may then confirm that the user's entry matches the authentication data on the server assembly 110. If a match is found, the user may be granted access to the functionality of the application 150 and, thus, the message system 100.

Some alternative implementations of the message system 100 may optionally provide a single sign-on option. For example, if a user is logged into his healthcare facility's medical records system, the message system 100 may receive authentication data from the medical records system. In that case, the user need not provide his login information to the message system 100 to begin a secure messaging session.

Some implementations may require two-factor authentication, where the user may be required to provide a password or pattern, in addition to providing biometric data (e.g., a fingerprint) or confirming that he has an authentication device, such as a secure flash drive inserted into the local computing device 50.

After a user is authenticated according to whatever standards are implemented, the message system 100 may allow the user access to one or more of an inbox, a search function, and a message-sending function. When the user views the inbox, the message system 100 may display one or more messages sent to the user through the system 100.

The messages appearing in the inbox may be stored on the server assembly 110 and, in some implementations, not on the local computing device 50. The benefit of this is that the message system 100 may exert more control over message security when they are not stored on the local computing device 110. When the user selects a message to read, the application 150 may display a view of the message in its internal web browser, or by some other appropriate means. The message system 100 may then mark the message as read.

In an example implementation, read messages in the inbox may be automatically deleted from the message system 100 if one or more predetermined conditions are met. For example, the message system 100 may delete all of the user's messages flagged as read after the user's current session ends. Alternatively, the message system may delete read messages after a predetermined timeframe, such as 72 hours. Unread messages may be deleted after a predetermined timeframe as well, such as two weeks. This latter timeframe may be chosen to provide adequate time for the user to read all messages, while at the same time limiting the number of messages stored on the server assembly 110 in case of malicious access.

Each user registered with the message system 100 may have a profile page displaying information about the user, including, for example, name, demographic information, photo, licensure, specialties, and health plan participation or affiliation. The profile page may also include a link that enables the user to send a message to the user associated with the profile page.

Each user may also be associated with a unique identifier, or script, generated and assigned by the message system 100. The identifier may be a computer-generated sequence of characters encoding various information about the user, such as name, state of licensure, and location. In some implementations, the location may be provided by the healthcare professional for inclusion in the script or other purposes. Alternatively, if the computing device 50 used by the user is capable of providing location data, such as through a GPS tracker, the message system 100 may use this data to determine the user's location. In some implementations, such location data may be used to further confirm a user's identity.

Various mechanisms for generating identifiers may be used by the message system 100. In some implementations, the identifier may be a string comprising two or more substrings ordered in a predetermined manner. For example, and not limitation, the identifier may comprise three substrings. The substrings may be separated from one another with an intervening period, or other appropriate character, between each adjacent pair of substrings.

The substrings may each have predetermined meanings known to the message system 100. In some implementations, the first substring of the identifier may be a concatenation of the first name and last name of the associated user. The second substring may be an abbreviation or other representation of the user's role in the healthcare profession. For example, this substring may indicate that the user is a medical student, pharmacist, nurse practitioner, social worker, administrator, or physician's assistant, etc. but not limited to these user types. If the user is a physician, this second substring may indicate the user's specialty. The third substring may indicate the user's location, such by providing the user's state of operation or, if the user is a medical student, an indication of the user's medical school. Each substring may be abbreviated according to predetermined abbreviations. Thus, the message system 100 may be capable of parsing each identifier to determine information about the associated user. Appendix A provides a list of abbreviations that may be used as the second and third substrings of the identifiers, according to this example implementation.

The users' identifiers may be used for various purposes, some of which may be for the convenience of the message system's processes, and some of which may be for the convenience of the users. For example, and not limitation, a first user may be able to search for other users with one or more filters provided by the application 150. When the filters are applied to all users, the application 150 may return search results in a display of the users satisfying the first user's search. Because of the form of the identifiers, the messaging system 100 may apply the filters to the identifiers themselves. For example, if the identifier encodes the location, the messaging server 100 may determine a user's location based only on the identifier. Thus, the identifiers may make search performance more efficient. In some implementations, however, search filters may be applied to a database maintaining data related to the various systems users, instead of or in addition to being applied to the identifiers.

Search results may include a list of Authorized Persons, who are users of the message system 100, represented by their unique identifiers. When the first user views the list of returned search results, he can almost immediately determine information about each user on the list based on the identifiers and the information encoded within. When the first user clicks on a particular search result, the application 150 may in response display the associated user's profile page, or may enable the first user to send a message to the selected user.

The identifiers may also be used to direct advertising at the users. Similar to how filters may be applied during searches, filters may also be applied to the identifiers for advertising purposes. For example, and not limitation, the messaging system 100 may identify users who practice certain healthcare specialties, based on the identifiers. The application 150 may then display advertising related to those specialties only to those users. For another example, the messaging system may identify users who practice or are currently located in a certain geographic area, and may display local ads to those users.

The application 150 may provide a means for a user to compose a message to one or more other users registered with the message system 100. The user may select message recipients, for example, by searching or by selecting the recipients from a list of previously saved users. When the user submits a message to the message system 100, directed at one or more particular recipients, the application 150 may securely transmit the message to the server assembly 110. In some implementations, the application 150 may encrypt the message before transmission.

After receiving a new message, the server assembly 110 may store the encrypted message, including any associated attachments, in association with its recipient and sender. The message system 100 may send to the recipient a notification that a new message has been received. In some implementations of the application 150, some processes of the application 150 may run in the background of the recipient's computing device 50, so as to present the new message notification to the recipient user when the message is received. However, the application 150 may display the message content only after the recipient user is engaged in an authenticated session with the application 150. In some implementations, the message system 100 may allow a user to download to the local computing device 50 messages he has sent or received. Other implementations, however, may disallow messages from being stored locally.

A user may exit a session with the message system 100 by timeout, logout, or other means. If the user is inactive within the application 150 for a predetermined period of time, the application 150 may automatically log the user out. This can prevent unauthorized access if someone else picks up the user's computing device 50 after the user has stopped using, but not logged out of, the application 150. The user may alternatively log out manually, such as by selecting a logout option provided in the application 150.

As needed, the message system 100 may remove certain data from the computing device 50 after the user's session has ended. For example, and not limitation, the application 150 may clear some or all of its application data from the computing device 50, so as to remove any healthcare-related messages that might remain in memory. Accordingly, this data would not remain on the computing device 50 where it might be seen or accessible by unauthorized people.

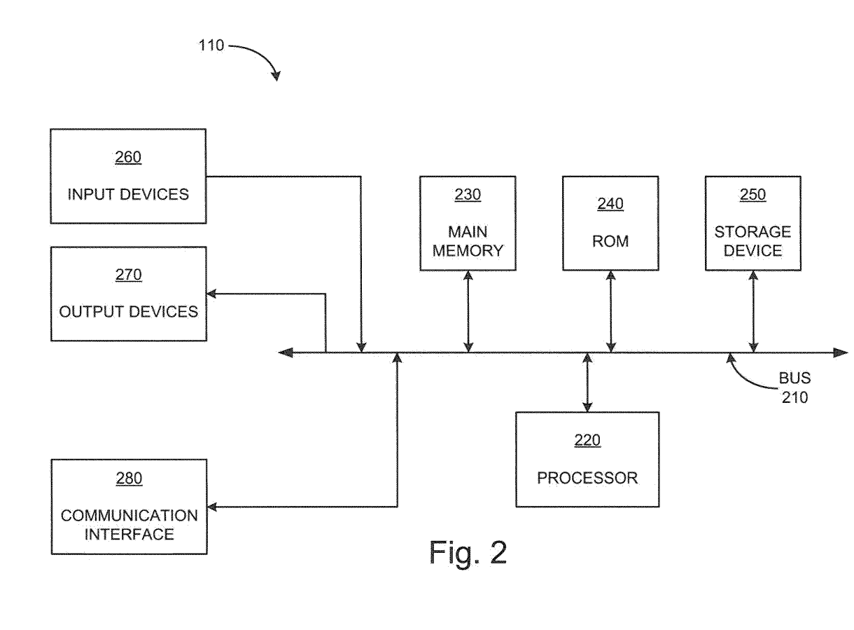

Various implementations of the message systems 100 and methods may be embodied in transitory or non-transitory computer-readable media for execution by a computer processor. FIG. 2 is a diagram of an example architecture of a portion of the server assembly 110, which supports functionality of the message system 100 as described above.

As shown, the server assembly 110 may include a bus 210, a processor 220, a main memory 230, a read only memory (ROM) 240, a storage device 250, one or more input devices 260, one or more output devices 270, and a communication interface 280. The bus 210 may include one or more conductors that permit communication among the components of the server assembly 110.

The processor 220 may be one or more conventional processors or microprocessors that interpret and execute instructions, such as instructions for providing aspects of the disclosed technology. The main memory 230 may include a random access memory (RAM) or another dynamic storage device that stores information and instructions for execution by the processor 220. The ROM 240 may include a conventional ROM device or another type of static storage device that stores static information or instructions for use by the processor 220. The storage device 250 may include a magnetic or optical recording medium and its corresponding drive.

The input devices 260 may include one or more mechanisms that permit an operator to input information to the server assembly 110, such as a keyboard, a mouse, a pen, voice recognition, biometric mechanisms, or any other medium which allows for data entry. The output devices 270 may include one or more mechanisms that output information to an operator, including a display, a printer, or a speaker. The communication interface 280 may include any transceiver-like mechanism that enables the server assembly 110 to communicate with remote devices or systems, such as the computing devices 50 employed by the various system users. For example, the communication interface 280 may include mechanisms for communicating over the network 10.

As discussed above, the server assembly 110 may manage message delivery to a plurality of computing devices 50. The server assembly 110 may perform tasks to that end in response to the processor 220 executing software instructions contained in a computer-readable medium, such as memory 230. The software instructions may be read into memory 230 from another computer-readable medium, such as the data storage device 250, or from another device via the communication interface 280. Alternatively, or additionally, hardwired circuitry may be used in place of or in combination with software instructions to implement processes consistent with the disclosed technology. Thus, the disclosed technology is not limited to any specific combination of hardware circuitry and software.

While the message systems 100 and methods have been disclosed in illustrative examples, it will be apparent to those skilled in the art that many modifications, additions, and deletions may be made without departing from the spirit and scope of the systems, methods, and their equivalents.

### APPENDIX A

### Abbreviations that May be Used in the Identifiers for System Users

### Abbreviations for Physicians

| | |
|---|---|
| Anesthesiology | ANES |
| Dermatology | DERM |
| Emergency medicine | EMERG |
| Family medicine | FMED |
| Internal medicine | INTMED |
| Adolescent medicine | ADLMED |
| Cardiology | CARD |
| Critical care medicine | CRCARE |
| Endocrinology, diabetes & | ENDO |
| metabolism | |
| Gastroenterology | GI |
| Geriatric medicine | GRMED |
| Hematology | HEME |
| Hospice and palliative medicine | HPMED |
| Infectious disease | ID |
| Oncology | ONC |
| Nephrology | RENAL |
| Pulmonary | PULM |
| Rheumatology | RHEUM |
| Sleep medicine | SLPMD |
| Sports medicine | SPORTS |
| Transplant hepatology | HEPA |
| Genetics | GENE |
| Neurosurgery | NSURG |
| Nuclear medicine | NMED |
| Obstetrics | OB |
| Gynecology | GYN |
| Obstetrics & gynecology | OBGYN |
| Ophtalmology | OPTH |
| Otolaryngology | ENT |
| Anatomic pathology | APATH |
| Clinical pathology | PATH |
| Pediatrics | PED |
| Physical medicine and rehab | PMR |
| Plastic surgery | PLSURG |
| Preventive medicine | PRVMED |
| Psychiatry | PSYCH |
| Neurology | NEURO |
| Child neurology | pNEURO |
| Radiology | RAD |
| Surgery | SURG |
| Cardiothoracic | CTSURG |
| Urology | URO |
| Orthopedics | ORTHO |

### Abbreviations for Roles Other than Physician

| | |
|---|---|
| Physician | md |
| Physician Assistant | pa |
| Nurse Practitioner | np |
| Nurse | nurse |
| Social Worker | socwrk |
| Medical Assistant | medast |
| Pharmacist | pharm |
| Administrator | admin |
| Medical Student | mdstud |

### Abbreviations for Medical Schools

| | |
|---|---|
| Emory University School of Medicine | emory |
| Georgia Health Sciences University | ghsu |
| Johns Hopkins University School of Medicine | jhusom |
| Morehouse School of Medicine | msm |
| U of Alabama | UAB |
| U of South Alabama | USA |
| AT Still University - Arizona | StillAZ |
| Midwestern University - Arizona | MidAZ |
| U of Arizona | UAriz |
| U of Arkansas | UArk |
| USC - Keck | Keck |
| Loma Linda University | Loma |
| Stanford University | Stnfrd |
| Touro University - California | TouroCA |
| UC San Diego | UCSD |
| UC Davis | UCDavis |
| UC Irvine | UCI |
| UC Los Angeles | UCLA |
| UC San Francisco | UCSF |
| Western University of Health Sciences | Pomona |
| Rocky Vista University | RockyV |
| U of Colorado | Denver |
| U of Connecticut | UConn |
| Yale University | Yale |
| George Washington University | GWU |
| Georgetown | Gtown |
| Howard University | Howard |
| Florida International University | FLIntl |
| Florida State University | FLState |
| Lake Erie COM - FL | LECOMFL |
| U of Miami | Miami |
| Florida Atlantic University | FAU |
| Nova Southeastern University | Nova |
| U of Central Florida | UCF |
| U of Florida | UF |
| U of South Florida | USF |
| Medical College of Georgia | MCG |
| Mercer University | Mercer |
| Philadelphia COM - Georgia | GAPCOM |
| U of Hawaii | Hawaii |
| U of Chicago | Chicago |
| Northwestern University | NWU |
| Midwestern University - Chicago | MidChi |
| U of Chicago - Pritzker | Pritzke |
| Rush Medical College | Rush |
| Southern Illinois University | SIU |
| Loyola University | Loyola |
| U of Illinois | UIC |
| Indiana University | Indiana |
| U of Iowa | Iowa |
| Des Moines University | Dmoines |
| U of Kansas | Kansas |
| U of Kentucky | UKen |
| U of Louisville | Klouis |
| U of Pikeville | Kpike |
| Louisiana State University | LSU |
| Tulane University | Tulane |
| U of New England | NewEng |
| U of Maryland | UMary |
| Uniformed Services U of the Health Sciences | USUHS |
| Boston University | Boston |
| Harvard University | Harvard |
| Tufts University | Tufts |
| U of Massachusetts | UMass |
| Michigan State University - MD | MichMD |
| Michigan State University - DO | MichDO |
| U of Michigan | UMich |
| Oakland University | Oakland |
| Wayne State University | Wayne |
| Mayo Clinic | Mayo |
| U of Minnesota | UMinn |
| U of Mississippi | UMiss |
| William Carey University | Carey |
| AT Still University - Missouri | StillMO |
| Kansas City University | KCU |
| Saint Louis University | StLouis |
| University of Missouri - Columbia | UMCol |
| University of Missouri - Kansas City | UMKC |
| Washington University | WashU |
| Creighton University | Creigh |
| University of Nebraska | UNeb |
| Touro University - Nevada | TouroNV |
| U of Nevada | Nevada |
| Dartmouth College | Geisel |
| U of Medicine & Dentistry of NJ - New Jersey | UMDNJ |
| U of Medicine & Dentistry of NJ - Robert | UMDNJRW |
| Wood | |
| Rowan University - Cooper | Cooper |
| U of Medicine & Dentistry of NJ - DO | UMDNJDO |
| U of New Mexico | UNewMex |
| Albany Medical College | Albany |
| Albert Einstein COM of Yeshiva U | AlbEin |
| Columbia University | Columbi |
| Hofstra University | Hofstra |
| Mount Sinai | MtSinai |
| New York Institute of Technology | NYCOM |
| New York Medical College | NYMC |
| New York University | NYU |
| SUNY - Stony Brook | StonyBr |
| SUNY - Upstate | SUNYus |
| SUNY - Downstate | SUNYds |
| Touro University - New York | TouroNY |
| SUNY - Buffalo | Buffalo |
| U of Rochester | URoch |
| Cornell University | Cornell |
| East Carolina University | Brody |
| Duke University | Duke |
| U of North Carolina | UNC |
| Wake Forest University | Wake |
| U of North Dakota | UND |
| Wright State University | Wright |
| Case Western Reserve University | Case |
| Cleveland Clinic | Lerner |
| Northeast Ohio Medical University | NEOMED |
| Ohio University | OhioU |
| Ohio State University | OSU |
| U of Cincinnati | UCinn |
| U of Toledo | Toledo |
| Oklahoma State U | OKState |
| U of Oklahoma | OU |
| Oregon Health & Science University | OHSU |
| The Commonwealth Medical College | TCMC |
| Drexel University | Drexel |
| Thomas Jefferson University | JMC |
| Lake Erie COM - Pennsylvania | LECOMPA |
| Pennsylvania State University | PenStat |
| U of Pennsylvania | UPenn |
| Pennsylvania College of Osteopathic Medicine | PCOM |
| Temple U | Temple |
| U of Pittsburgh | Pitt |
| Universidad Central del Caribe | Caribe |
| Ponce School of Medicine | Ponce |
| San Juan Bautista School of Medicine | SJB |
| U of Puerto Rico | Rico |
| Brown University | Brown |
| Medical University of South Carolina | MUSC |
| U of South Carolina | USCaro |
| Virginia COM - South Carolina | VCOMSC |
| U of South Dakota | SDakota |
| East Tennessee State University | Etenn |
| Lincoln Memorial University | LMU |
| Meharry Medical College | Meharry |
| U of Tennessee | UTenn |
| Vanderbilt University | Vandy |
| Baylor University | Baylor |
| Texas A&M University | TexasAM |
| Texas Tech University | TXTech |
| U of North Texas | NorthTX |
| U of Texas - Houston | Houston |
| U of Texas - San Antonio | UTSA |
| U of Texas - Galveston | UTMB |
| U of Texas - Dallas | Dallas |
| U of Utah | Utah |
| U of Vermont | Vermont |
| East Virginia Medical School | EVMS |
| U of Virginia | UVA |
| Virginia COM - Virginia | VCOMVA |
| Edward Via Virginia COM | EdVia |
| Virginia Tech Carilion SOM | VATech |
| Pacific Northwest University | PacNW |
| U of Washington | UWash |
| West Virginia School of Osteopathic Medicine | WVSOM |
| West Virginia University SOM | WVU |
| Marshall University | Marsh |
| Medical College of Georgia | MCW |
| U of Wisconsin | Wisc |

1. A method of controlling HIPAA compliant remote access to patient-related medical information by one or more users, comprising:
registering one or more users to authenticate an identity of the one or more users;
assigning an identifying script which is unique to each of the one or more users;
storing the identifying script on a remote server which is electronically accessible via a local computing device and which is used by the one or more users, where the local computing device is programmed to communicate with the remote server or is accessible via a network;
alerting the one or more users via the local computing device of at least one message received from at least one additional user, where the at least one message is stored on the remote server;
presenting an authentication screen to the one or more users on the local computing device, where the authentication screen prompts for entry of a pattern by the one or more users; and
if the pattern entered by the one or more users matches an authenticating pattern stored by the remote server, then displaying the at least one message to the one or more users on the local computing device.

2. The method of claim 1 wherein assigning an identifying script comprises assigning a computer-generated sequence of characters to the one or more users.

3. The method of claim 1 further comprising targeting advertisement to the one or more users within a predetermined specialty or geographic location based on the identifying script.

4. The method of claim 1 wherein assigning an identifying script further comprises altering the identifying script associated with a particular profile of at least one of the users.

5. The method of claim 4 wherein the identifying script associated with the particular profile is altered to provide targeted access to one or more of the registered users.

6. The method of claim 1 wherein the at least one message drafted by the at least one additional user is transmitted to the remote server for temporary storage.

7. The method of claim 1 wherein alerting the one or more users comprises displaying a notification of the at least one message to the one or more users.

8. The method of claim 1 wherein the pattern for entry comprises a predetermined layout of symbols where the one or more users trace a pattern connecting two or more of the symbols for authentication purposes.

9. The method of claim 1 wherein presenting an authentication screen further comprises presenting one or more fields for the user to fill out.

10. The method of claim 9 wherein the one or more fields comprises entry of a username.

11. The method of claim 9 wherein presenting an authentication screen comprises further requiring biometric data unique to the one or more users for entry via the local computing device.

12. The method of claim 1 further comprises deleting the at least one message from the remote server when one or more predetermined conditions are satisfied.

13. The method of claim 12 wherein the at least one message is automatically deleted from the remote server after displaying unless affirmatively saved by the one or more users.

14. The method of claim 12 wherein the at least one message is automatically deleted from the remote server after a predetermined period of time has elapsed after displaying.

15. The method of claim 12 wherein the at least one message is automatically deleted from the remote server after the local computing device is logged out.

16. The method of claim 1 wherein the remote server is in communication with a plurality of local computing devices via a network.

17. The method of claim 1 wherein the local computing device comprises a mobile phone, tablet, desktop computer, or notebook computer.

18. The method of claim 1 wherein the local computing device comprises a touch sensitive screen.

19. The method of claim 1 wherein the local computing device is programmed via an application.

20. A system for controlling HIPAA compliant remote access to patient-related medical information, comprising:
a remote server having one or more processors and a memory storage module;
a plurality of local computing devices which are in communication with the remote server over a network;
wherein each of the local computing devices are programmed via an application to communicate with the remote server and to present an authentication screen which prompts for entry of a pattern by a user,
wherein the remote server is configured to store an identifying script which is unique to each of one or more users in the memory storage module,
wherein the one or more processors are programmed to alert at least one of the local computing devices of at least one message when received from the local computing device of at least one additional user and which is further programmed to allow access to the at least one message by the user if the pattern entered by the user on the local computing device matches with an authenticating pattern stored by the remote server.

21. The system of claim 20 wherein the local computing devices comprise mobile phones, tablets, desktop computers, or notebook computers.

22. The system of claim 20 wherein the identifying script is generated via the remote server and matched to the authenticating patter.

23. The system of claim 20 wherein the at least one message is stored by the remote server for temporary storage.

24. The system of claim 20 wherein the pattern for entry comprises a predetermined layout of symbols which when traced into two or more connecting symbols provide for the pattern.

25. The system of claim 20 wherein the local computing devices are further programmed to present one or more fields for the user to fill out.

26. The system of claim 20 wherein the local computing devices are further programmed to require biometric data unique to the user for entry via the local computing device.

27. The system of claim 20 wherein the one or more processors are further programmed to delete the at least one message from the remote server when one or more predetermined conditions are satisfied.

28. The system of claim 27 wherein the one or more processors are further programmed to delete the at least one message from the remote server after displaying unless affirmatively saved by the user.

29. The system of claim 27 wherein the one or more processors are further programmed to delete the at least one message from the remote server after a predetermined period of time has elapsed after displaying.

30. The system of claim 27 wherein the one or more processors are further programmed to delete the at least one message from the remote server after the local computing device is logged out.

31. The system of claim 20 wherein the plurality of local computing devices each comprise a touch sensitive screen.

32. The method of claim 1 wherein the at least one message stored on the remote server comprises a voice message.

33. The method of claim 1 further comprising transmitting a message relating to the medical information by the one or more users for storage on the remote server.
